(19) United States
(12) Patent Application Publication
(10) Pub. No.: US 2014/0152889 A1
(43) Pub. Date: Jun. 5, 2014

(54) HOLE ENLARGING DEVICE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/968,383

(22) Filed: Aug. 15, 2013

(30) Foreign Application Priority Data
Dec. 4, 2012 (TW) 101145551

(51) Int. Cl. H04N 5/225

(52) U.S. Cl. CPC H04N 5/2251
USPC 348/373

(57) ABSTRACT

A hole enlarging device for a moveable lens module carrier of a camera includes: an electrical heater, a fixing device and a supporter. The electrical heater includes a heating portion, a clamping member and a plurality of cylindrical metallic rods with different diameters, one of the cylindrical metallic rods being fixed by the clamping member. The heating portion is configured to heat the cylindrical metallic rod. The fixing device is used for fixing the electrical heater and keeping the cylindrical metallic rod vertical. The supporter includes a receiving recess configuring for receiving and holding the moveable lens module carrier, the supporter is driven to move so as to apply the cylindrical metallic rod to the hole for resizing.

### BACKGROUND

1. Technical Field

The present disclosure relates to hole enlarging devices .

2. Description of Related Art

Camera actuators are used for achieving auto-focus functions. A camera actuator includes a guide pole and a moveable carrier defining a bushing hole. The guide pole extends through the bushing hole and moves lenses along an optical axis of a camera to realize the auto-focus function. The effect of auto-focus function is determined by a clearance between the guide pole and the bushing hole of the moveable carrier. When designing, a lot of moveable carriers are needed in which the bushing hole with different diameters are applied to obtain an optimum auto-focus function. Generally, the moveable carrier is formed by an injection molding process. So it needs to constantly resize the mold insert in order to obtain different moveable carriers with different-diameters bushing holes before the injection molding process. This is a waste of resource and money.

Therefore, it is desired to provide a hole enlarging device which can overcome the above mentioned problems.

### BRIEF DESCRIPTION OF THE DRAWINGS

FIG. 1 is an, isometric view of a hole enlarging device according to an exemplary embodiment.

FIG. 2 is an exploded view of the hole enlarging device of FIG. 1.

FIG. 3 is a schematic, isometric view of a support for the hole enlarging device of FIG. 1.

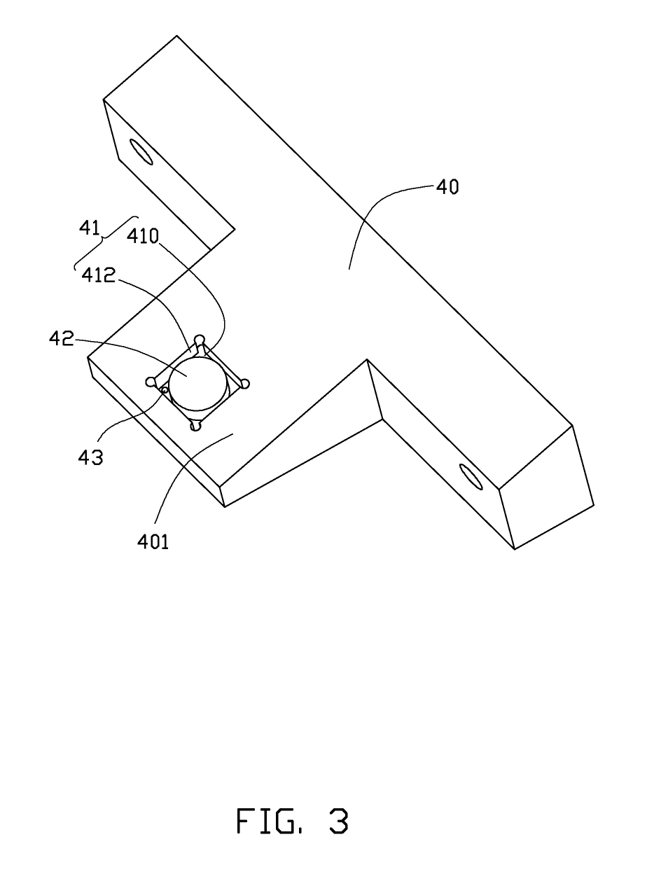

FIG. 4 is a schematic, isometric view showing a hole enlarging method using the hole enlarging device of FIG. 1.

FIG. 5 is an enlarged view of a circled part V of FIG. 4.

FIG. 6 is a schematic, isometric view of a movable carrier engaged with a guide pole.

### DETAILED DESCRIPTION

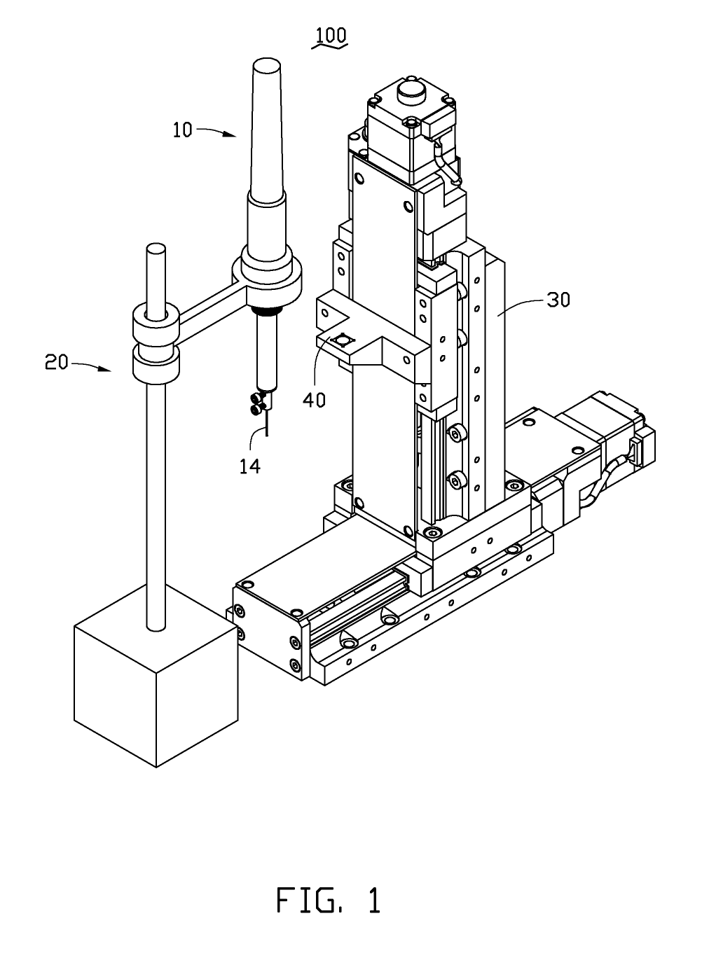

FIG. 1 shows a hole enlarging device 100 for enlarging a guide hole of a moveable carrier of a camera actuator according to an exemplary embodiment. The hole enlarging device 100 includes an electrical heater 10, a fixing device 20, a driving apparatus 30, and a support 40.

The electrical heater 10 includes a heating portion 17, a clamping member 12 and a number of cylindrical metallic rods 14 with different diameters. The clamping member 12 is connected with the heating portion 17 and configured for selectively clamping one of the cylindrical metallic rods 14 by bolts 16. The heating portion 17 is used for heating the cylindrical metallic rod 14 on the clamping member 12. The heating portion 17 has a circular protrusion 171 along the circumference of the heating portion 17. The heating portion 17 may include a printed circuit board (not shown), and have a controller (not shown) on the printed circuit board. The controller controls on and off of the heating portion 17 and a heating temperature of the heating portion 17.

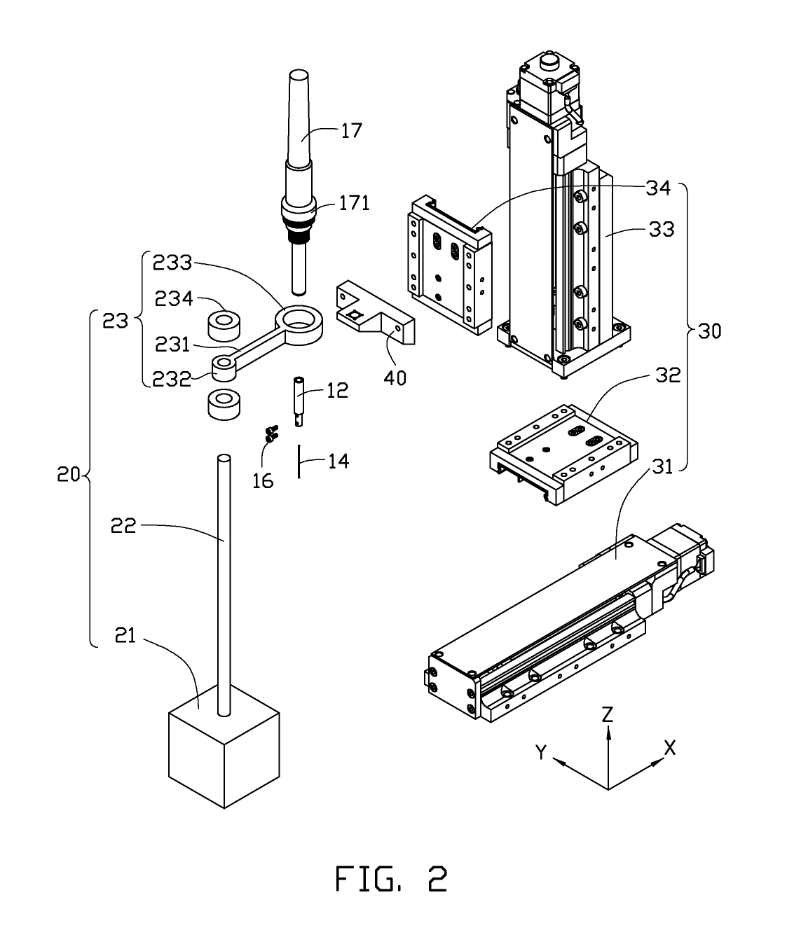

As shown in FIG. 2, the fixing device 20 includes a base 21, a supporting rod 22 perpendicularly fixed on the base 21 and a holding member 23 fixed on the supporting rod 22. The holding member 23 includes two lock nuts 234, a first ring 232, a second ring 233 and an arm 231 connecting the first ring 232 and the second ring 233. A diameter of the circular protrusion 171 is larger than an interior diameter of the second ring 233. The first ring 232 fits the supporting rod 22 and is fixed on the supporting rod 22 by two lock nuts 234. The electrical heater 10 extends through the second ring 233 and the circular protrusion 171 is placed on the second ring 233 to keep the cylindrical metallic rod 14 vertical orientation.

The driving apparatus 30 is a two-dimensional driving apparatus. The driving apparatus 30 includes a pedestal 31, a first moving plate 32 arranged on the pedestal 31, a vertical arm 33 arranged on the first moving plate 32, and a second moving plate 34 arranged on the vertical arm 33. The driving apparatus 30 bears the supporter 40. Specifically, the supporter 40 is fixed on the second moving plate 34 of the driving apparatus 30. The first moving plate 32 is horizontally movable and the second moving plate 34 is vertically moveable.

The supporter 40 is fixed on the second moving plate 34. The supporter 40 is T-shaped and includes a tab 401 defining a receiving recess 41. The recess 41 is configured for receiving a moveable carrier of a camera actuator. The supporter 40 includes a bottom surface 410 and four side surfaces 412. The bottom surface 410 and the four side surface 412 cooperatively form the receiving recess 41. A protrusion 42 is formed on the bottom surface 410. The supporter 40 further defines a through hole 43. The through hole 43 extends through the bottom surface 410 and is adjacent to the protrusion 42. A diameter of the through hole 43 is larger than a diameter of the cylindrical metallic rod 14. The supporter 40 can move with the first moving plate 32 and the second moving plate 34 to cause the insertion of the cylindrical metallic rod 14 into the through hole 43.

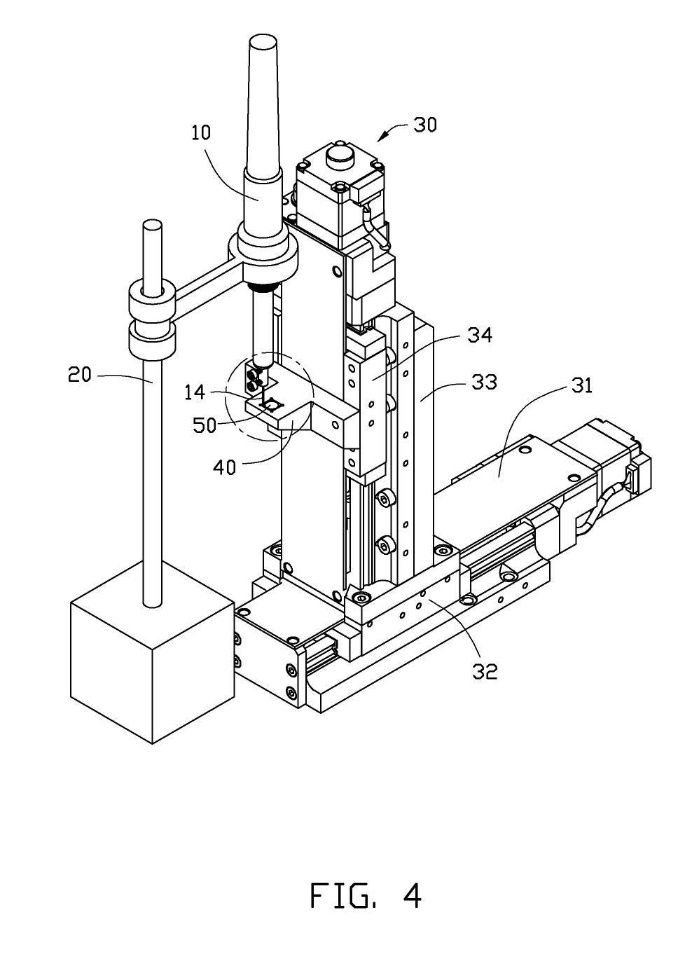

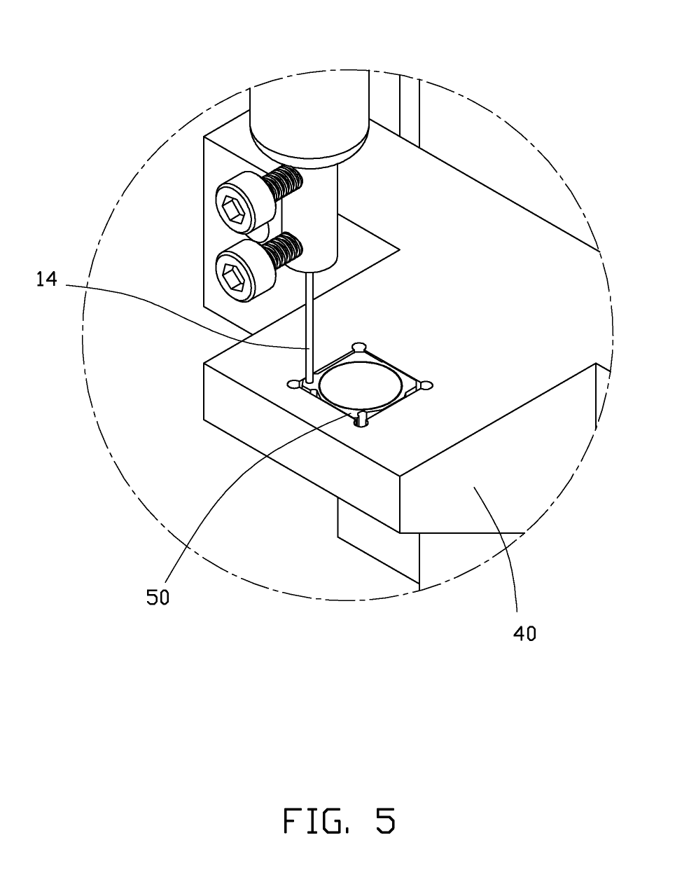

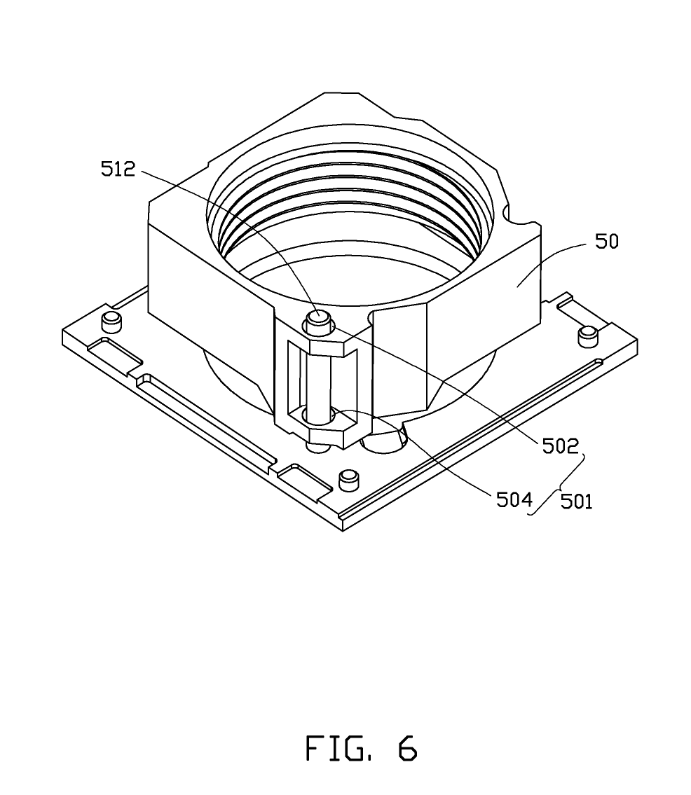

Referring to FIGS. 4-7, a hole enlarging method using the enlarging device 100 is shown. The enlarging method includes the following steps.

Step S1: a moveable carrier 50 and a guide pole 512 of a camera actuator are provided. The moveable carrier 50 is used for receiving a lens module. The moveable carrier 50 is made of plastic and includes a first pre-bushing hole 502 and a second coaxial pre-bushing hole 504. An interior diameter of the first pre-bushing hole 502 is substantially equal to an interior diameter of the second pre-bushing hole 504. The first pre-bushing hole 502 and the second pre-bushing hole 504 cooperatively form a pre-bushing hole 501. An interior diameter of the pre-bushing hole 501 is substantially the same as a diameter of the guide pole 512.

Step S2: the hole enlarging device 100 is provided. The moveable carrier 50 is put into the receiving recess 41 of the enlarging device 100 and the pre-bushing hole 501 is aligned with the through hole 43.

Step S3: the circular rod 14 is heated. The driving apparatus 30 drives the first moving plate 32 and the second moving plate 34. The supporter 40 moves with the first moving plate 32 and the second moving plate 34 along the horizontal direction (shown as an X axis direction in FIG. 2) and the vertical direction (shown as a Z axis direction in FIG. 2) to insert the heated circular rod 14 into the pre-bushing hole 501. The temperature of the circular rod 14 is controlled between 80° C. and 120° C. Plastic can be melted under the temperature between 80° C. and 120° C. In this way, the interior diameter of the pre-bushing hole 501 is expanded and a bushing hole is obtained.

Step S4: the driving apparatus 30 drives the first moving plate 32 and the second moving plate 34. The supporter 40 moves with the first moving plate 32 and the second moving plate 34 along the X axis direction and the Z axis direction to move the heated circular rod 14 away the pre-bushing hole 501.

Step S5: the moveable carrier 50 is taken off from the receiving recess 41 after hole enlarging. The hole enlarging device 100 can conveniently resize a bushing hole with any interior diameter quickly by using different-diameter cylindrical metallic rod.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of portion within the principles of the disclosure to the full extent indicated by the broad general meaning of the terms in which the appended claims are expressed.

What is claimed is:

1. A hole enlarging device for enlarging a bushing hole of a moveable carrier of a camera actuator, the hole enlarging device comprising:
an electrical heater comprising a heating portion, a clamping member and a plurality of cylindrical metallic rod with different diameters, the clamping member configured for selectively clamping one of the cylindrical metallic rods, the heating portion configured to heat the clamped cylindrical metallic rod;
a fixing device used for fixing the electrical heater and keeping the cylindrical metallic rod in a vertical orientation;
a supporter comprising a receiving recess configuring for receiving a moveable carrier, the moveable carrier comprising a bushing hole, the supporter being movable so as to make the cylindrical metallic rod insert into the bushing hole and to enlarge the bushing hole.

2. The hole enlarging device of claim 1, further comprising a driving apparatus for moving the supporter.

3. The hole enlarging device of claim 2, wherein the driving apparatus comprises a pedestal, a first moving plate arranged on the pedestal, a vertical arm arranged on the first moving plate, a second moving plate arranged on the vertical arm, the first moving plate is horizontally movable and the second moving plate is vertically movable, and the supporter is fixed on the second moving plate.

4. The hole enlarging device of claim 1, wherein the supporter is T shape and comprises a tab, and the tab defines the receiving recess.

5. The hole enlarging device of claim 1, wherein the receiving recess comprises a bottom surface and four side surfaces, a protrusion is formed on the bottom surface.

6. The hole enlarging device of claim 5, wherein the supporter comprises a through hole, the through hole extends through the bottom surface and is adjacent to the protrusion.

7. The hole enlarging device of claim 1, wherein the heating portion is connected with the clamping member.

8. The hole enlarging device of claim 6, wherein a diameter of the through hole is larger than a diameter of the clamped cylindrical metallic rod.

9. The hole enlarging device of claim 5, wherein the protrusion is cylindrical.

10. The hole enlarging device of claim 1, wherein the fixing device comprises a base, a supporting rod perpendicularly fixed on the base and a holding member fixed on the supporting rod, the holding member comprises a first ring, a second ring and an arm connecting the first ring and the second ring.

11. The hole enlarging device of claim 10, wherein the first ring is fixed to the supporting rod, and the second ring is configured for receiving the electric heating device.
